(19) United States
(12) Patent Application Publication
(10) Pub. No.: US 2025/0066250 A1
(43) Pub. Date: Feb. 27, 2025

(54) GEOPOLYMER FORMULATION AND METHOD OF MAKING AND APPLYING FORMULATION

(71) Applicants: Emmanuel Roy, Salt Spring Island (CA); William Hoff, Las Vegas, NV (US); Jon Scott, Salt Spring Island (CA); Andrey Dudnikov, Charleston, SC (US)

(72) Inventors: Emmanuel Roy, Salt Spring Island (CA); William Hoff, Las Vegas, NV (US); Jon Scott, Salt Spring Island (CA); Andrey Dudnikov, Charleston, SC (US)

(21) Appl. No.: 18/815,705

(22) Filed: Aug. 26, 2024

Related U.S. Application Data
(60) Provisional application No. 63/578,491, filed on Aug. 24, 2023.

(51) Int. Cl. C04B 28/00; B28B 3/26; C04B 40/00; C04B 103/12; C04B 111/00

(52) U.S. Cl. CPC C04B 28/006; C04B 40/0046; B28B 3/26; C04B 2103/12; C04B 2111/00129

(57) ABSTRACT

A geopolymer formulation comprises a precursor, a reagent, and an accelerator, wherein said precursor and reagent and are mixed to form a paste, the accelerator is then added to and mixed with paste. The foundation becomes set and available for use immediately after adding and mixing of the accelerator with the paste. A method of making and applying a geopolymer formulation, includes mixing a precursor and a reagent, introducing the precursor and reagent mixture into an extruder and nozzle assembly, adding an accelerator to the precursor and reagent mixture and mixing the accelerator with the precursor and reagent mixture, and dispensing the formed geopolymer product out of the extruder and nozzle assembly after mixing the accelerator with the precursor and reagent mixture.

### CROSS-REFERENCE TO RELATED APPLICATIONS

The present application is a non-provisional application of and claims priority under 35 U.S.C. § 119 on pending U.S. Provisional Patent Application Ser. No. 63/578,491, filed on Aug. 24, 2023, the disclosure of which is incorporated by reference.

### FIELD OF THE DISCLOSURE

The present disclosure relates to geopolymers, and more particularly, to a geopolymer-based formulation and method for making the same for use as construction and building materials.

### BACKGROUND

Geopolymer-based mortars, concrete mixes, and other products are favorable for a relatively low environmental impact in the course of their production, such as lowered amounts of carbon dioxide emissions. Such products are useful as building materials and flame-retardant barriers. Geopolymer mortars, concretes, and other products may be dispensed by a 3D printer, a nozzle, or a hose for example, to create a structure or structural component.

When such a geopolymer is formed, it is subject to a setting time and a hardening time. For instance, when Portland cement is mixed with water (such as may be done in the preparation), the cement is hydrated to form a cement paste. This paste can be molded into any desired shape due to its plasticity. During this time cement continues to react with the water, and slowly cement starts losing its plasticity and starts to harden. This period is often described as the setting time. Hardening time can mean the time that it takes for the cement to reach substantial or complete rigidity. Control of setting time and hardening time is of particular importance when the geopolymer material is to be applied or dispensed by a 3D printer, nozzle, or hose.

However, presently-known methods of controlling setting and hardening time are not sufficient to allow efficient creation of building structures, etc. with a 3D printer. That is, in producing geopolymer-based building components with a 3D printer, the printer traditionally creates the component as a series of relatively thin layers that are compiled on top of one another. It is a requirement in the current art that lower layers must harden before further layers are applied on top of the lower layers. Without a quick hardening of a layer, the 3D printing process must stop until the lower layer has hardened sufficiently to support another layer being dispensed on top of it. The result is a slow building process.

### SUMMARY OF THE DISCLOSURE

In view of the foregoing disadvantages of the prior art, a geopolymer formulation and method of making and applying the same is disclosed that overcomes these drawbacks and allows for quick and efficient production of construction and building components. Accordingly, a geopolymer formulation and method of making and applying the same is provided that allows for precise control of setting times and hardening times as well as novel use of an accelerator for achieving such control.

In an embodiment, a geopolymer product comprises a precursor, a reagent, and an accelerator. The precursor, reagent, and accelerator form a geopolymer binder, which binder, when mixed, forms a mortar or concrete. In an embodiment, the precursor and reagent are mixed for a certain amount of time until geopolymerization of the mix occurs. Geopolymerization, as used herein, may be the process of the precursor and reagent transforming into a three-dimensional network consisting of covalent bonds. Thereafter, aggregate or aggregates may be added to the geopolymerized mix. After further mixing, a mortar or concrete paste is formed.

Thereafter, the accelerator is added to the mix. The accelerator preferably is added when hardening is needed, such as during casting of a building component or extrusion of the mixed product from a 3D printer.

In an embodiment, the accelerator may be added at the very end of the extrusion process (i.e., when all mixing is nearly done and the finished mix is about to be dispensed by a nozzle or a hose) by injecting or pumping the accelerator into the mix and then subsequently further mixing the accelerator with the mix before extruding the final mixed product.

In another embodiment, a method of creating and applying a geopolymer product is provided. The method comprises the steps of mixing a precursor with a reagent until these ingredients undergo geopolymerization, and then adding and mixing an accelerator with the geopolymerized mix just prior to extrusion of the mix of all ingredients before dispensing or extruding the mix of all ingredients to form a structure or object. The precursor may comprise the exemplary precursors set forth elsewhere herein, the reagent may comprise the exemplary reagents set forth elsewhere herein, and the accelerator may comprise the exemplary accelerator set forth elsewhere herein.

These together with other aspects of the present disclosure, along with the various features of novelty that characterize the present disclosure, are pointed out with particularity in the drawings and claims annexed hereto and form a part of the present disclosure.

### DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a longitudinal cross-sectional view of an extruder and nozzle assembly for dispensing a geopolymer formulation, in accordance with an exemplary embodiment of the present disclosure; and

FIG. 2 is a longitudinal cross-sectional view of an extruder and nozzle assembly for dispensing a geopolymer formulation, in accordance with another exemplary embodiment of the present disclosure.

### DETAILED DESCRIPTION OF THE DISCLOSURE

The best mode for carrying out the present disclosure is presented in terms of its preferred embodiment, herein depicted in the accompanying figure. The preferred embodiments described herein detail for illustrative purposes are subject to many variations. It is understood that various omissions and substitutions of equivalents are contemplated as circumstances may suggest or render expedient but are intended to cover the application or implementation without departing from the spirit or scope of the present disclosure. Furthermore, although the following relates substantially to one embodiment of the design, it will be understood by those familiar with the art that changes to materials, part descriptions and geometries can be made without departing from the spirit of the disclosure.

The terms “a” and “an” herein do not denote a limitation of quantity, but rather denote the presence of at least one of the referenced items.

In an embodiment, a geopolymer product comprises a precursor, a reagent, and an accelerator. The precursor, reagent, and accelerator form a geopolymer binder, which binder, when mixed, forms a mortar or concrete. In an embodiment, the precursor and reagent are mixed for a certain amount of time until geopolymerization of the mix occurs. Geopolymerization, as used herein, may be the process of the precursor and reagent transforming into a three-dimensional network consisting of covalent bonds. Thereafter, aggregate or aggregates (such as sands or a mix of sands such as quartz sand, feldspar sand, Chamotte sand and others; gravels or mix of gravels such as granite, basalt and others; fibers natural and/or synthetic, such as polypropylene, wooden, basalt and others) may be added to the geopolymerized mix. After further mixing, a mortar or concrete paste is formed.

Thereafter, the accelerator is added to the mix. The accelerator can be added in a liquid form into the dry precursor, into a dry, liquid, slurry, or suspension form of the mix of the reagent and precursor, or into a mortar or concrete form. The accelerator preferably is added when hardening is needed, such as during casting of a building component or extrusion of the mixed product from a 3D printer.

In an embodiment, the accelerator may be added at the very end of the extrusion process (i.e., when all mixing is nearly done and the finished mix is about to be dispensed by a nozzle or a hose) by injecting or pumping the accelerator into the mix and then subsequently further mixing the accelerator with the mix before extruding the final mixed product. This can be accomplished by feeding the accelerator into the existing mix with an extension delivery mechanism that is securely operatively coupled to the region in which the existing mix has been mixed, in order to ensure a proper homogenization of the geopolymer mix and the accelerator.

In an embodiment, the precursor comprises an inorganic, amorphous alumino-silicate mineral material, such as fly-ash type F or similar, metakaolin naturally or industrially obtained, naturally calcined caolinitic clay minerals, laterites, ferro-sialates, metallurgical slag, other types of metallurgical by-products, volcanic tuffs (whether calcined or not), mine tailings, silica fumes, microsilica, synthetic or natural zeolites, pumice, pozzolanic materials, mika, muscovite and others or a mix of the preceding items.

In an embodiment, the reagent comprises a silicate of an alkaline metal or an acid.

In an embodiment, the accelerator comprises a mineral origin or a group of minerals. In an exemplary embodiment, the accelerator comprises one or more of gehlenite (Ca₂Al(AlSi)O₇), akermanite (Ca₂MgSi₂O₇), belite (2CaO*SiO2), alite (3Ca0-Si02), monocalcium aluminate (CaAl2O), and anorthite Ca[Al2Si2O8].

In another embodiment, a method of creating and applying a geopolymer product is provided. The method comprises the steps of mixing a precursor with a reagent until these ingredients undergo geopolymerization, and then adding and mixing an accelerator with the geopolymerized mix just prior to extrusion of the mix of all ingredients before dispensing or extruding the mix of all ingredients to form a structure or object. The precursor may comprise the exemplary precursors set forth elsewhere herein, the reagent may comprise the exemplary reagents set forth elsewhere herein, and the accelerator may comprise the exemplary accelerator set forth elsewhere herein.

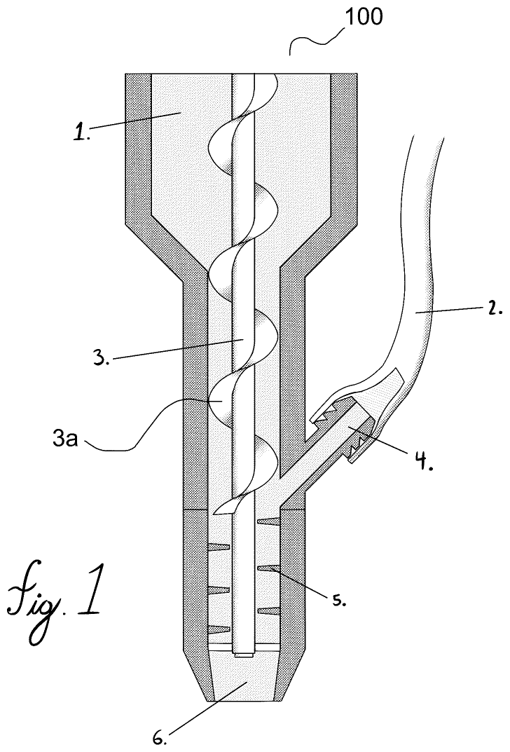

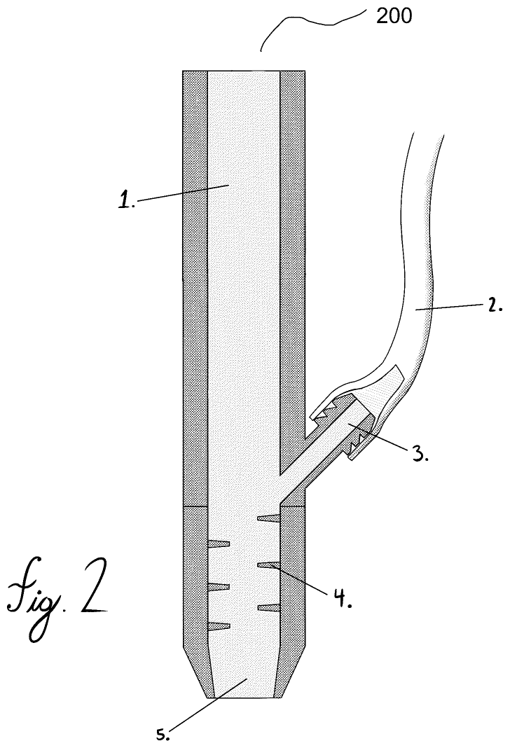

In an embodiment, application of the geopolymer disclosed herein is performed via a 3D printer. As shown in exemplary embodiment in FIGS. 1 and 2, such a printer comprises an extruder and nozzle assembly 100 and 200 (also referred to as an “extruder assembly”) through which a geopolymer is applied or extruded.

In an embodiment, and referring to FIG. 1, the extruder and nozzle assembly 100 comprises a region 1 that receives the precursor/reagent (but unset) mixture. At the end of the extruder that is distal to this region 1 is a nozzle 5. The extruder assembly 100 also includes at least one drive shaft 3 that is operatively coupled to a motor (not shown) and is capable of performing rotational movement within the extruder. In an embodiment, at least a portion of the drive shaft 3 comprises a push screw 3a or other threaded configuration. When the shaft 3 rotates, the screw 3a or threaded configuration facilitates forcing the precursor/reagent mixture toward the nozzle 6. Proximate to the nozzle 6 is a port 4 through which the accelerator may be introduced into the extruder assembly 100. It will be apparent that the accelerator is sequestered from the precursor/reagent mixture until the accelerator is delivered through the port 4 into extruder assembly 100. The accelerator may be delivered from a supply source via a tube or hose 2 that attaches to the port.

More proximate to the nozzle 6, the extruder assembly 100 comprises a mixing chamber or region wherein the accelerator is mixed with the precursor and reagent. In an embodiment, the mixing region comprises a plurality of protrusions 5 that are disposed on an interior wall of the extruder assembly 100 that extend toward further toward the interior of the extruder assembly. After the accelerator is introduced into the extruder assembly, the drive shaft 3 rotates to continue to force the precursor/reagent mixture (and accelerator, now present) toward the nozzle 6. When this new mixture reaches the mixing region, the protrusions agitate the accelerator and precursor/reagent mixture as they are forced past the protrusions by the drive shaft. The agitation results in mixing of the accelerator with the precursor so that fully mixed geopolymer can then be dispensed through the nozzle 6.

Once the accelerator, precursor and reagent have been sufficiently mixed to form the geopolymer product, the product may be dispensed through the nozzle 6. The product may be dispensed through nozzle 6 by the continued force of the rotating drive shaft 3, for example, or by external pressure.

In another embodiment, and as shown in FIG. 2, an extruder assembly 200 omits a drive shaft with a threaded region. The precursor and reagent introduced into region 1 of assembly 200 can be moved toward the nozzle by the force of gravity, for example, or by external pressure. The extruder assembly 200 comprises a mixing chamber or region wherein the accelerator is mixed with the precursor and reagent. In an embodiment, the mixing region comprises a plurality of protrusions 5 that are disposed on an interior wall of the extruder assembly 200 that extend toward further toward the interior of the extruder assembly. After the accelerator is introduced into the extruder assembly the precursor/reagent mixture (and accelerator, now present) move toward the nozzle 6 through the force of gravity or external pressure source, for example. When this new mixture reaches the mixing region, the protrusions agitate the accelerator and precursor/reagent mixture as the mixture is forced past the protrusions. The agitation results in mixing of the accelerator with the precursor so that fully mixed geopolymer product can then be dispensed through the nozzle 6.

Because the accelerator is introduced into the mix just before dispensing or extruding the mixed product out of extruder assembly 100 or 200, the setting time of the geopolymer product formed herein can be shortened drastically because of the short amount of time before introduction of the accelerator and dispensing or extruding of the mix. That is, the problem of setting of the mix prior to dispensing or extruding is rendered moot because there is no time for the mix to become set before it is extruded. It will be apparent that setting time can be reduced by increasing the relative concentration of accelerator in the mix. In this fashion, the geopolymer product can set almost immediately after it is extruded from or dispensed by a 3D printer, for example, thus permitting dispensing or extrusion of the geopolymer product as quickly as final mix can be prepared, i.e., without regard to setting time of the final mix.

The disclosure therefore allows preparation of a geopolymer product with a high fluidity, with easy pumpability through the pump of a 3D printer application, allowing the 3D printing of structures at an angle of inclination from the vertical, such as arches, domes, sculptures etc.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A geopolymer formulation, said formulation comprising a precursor, a reagent, and an accelerator;
wherein said precursor and are said reagent mixed to form a paste;
wherein said accelerator is then added to said paste;
wherein said formulation is formed by further mixing of said accelerator and paste; and
wherein said formulation is set immediately after mixing of said accelerator and said paste.

2. The geopolymer formulation of claim 1, wherein said formulation further comprises at least one aggregate that is added to said paste before said accelerator is added to said paste.

3. The geopolymer formulation of claim 1, wherein said precursor comprises at least one of an inorganic, amorphous alumino-silicate mineral material, metakaolin, a naturally-calcined caolinitic clay mineral, a laterite, a ferro-sialate, metallurgical slag, a volcanic tuff, a mine tailing, a silica fume, microsilica, a zeolite, pumice, a pozzolanic material, mika, muscovite or a mix of any of thereof.

4. The geopolymer formulation of claim 1, wherein said accelerator comprises at least one of gehlenite, akermanite, belite, alite, monocalcium aluminate, and anorthite.

5. The geopolymer formulation of claim 1, wherein said accelerator is added to said paste immediately before extrusion of said geopolymer formulation.

6. A method of making and applying a geopolymer formulation, the method comprising
(a) mixing a precursor and a reagent;
(b) introducing said precursor and reagent into an extruder and nozzle assembly;
(c) adding an accelerator to said precursor and reagent mixture;
(d) mixing said accelerator with said precursor and reagent mixture; and
(e) dispensing said mixture of said accelerator, precursor and reagent out of said extruder and nozzle assembly through said nozzle immediately after mixing said accelerator with said precursor and reagent mixture.

7. The method of claim 6, the extruder and nozzle assembly comprising
a region for receiving said precursor and reagent mixture;
a port;
a mixing region, said mixing region comprising a plurality of protrusions; and
a nozzle;
wherein said accelerator is added to said precursor and reagent mixture through said port;
wherein said accelerator and said precursor and reagent mixture are mixed by said protrusions of said mixing region to form a geopolymer product; an
wherein formed geopolymer product is dispensed out of said extruder and nozzle assembly through said nozzle immediately upon mixture of said accelerator and said precursor and reagent.

8. The extruder and nozzle assembly of claim 6, said assembly further comprising a drive shaft, said drive shaft comprising a threaded configuration,
wherein said drive shaft may rotate to actuate said precursor and reagent mixture within said assembly.

9. The method of claim 6, wherein said formulation further comprises at least one aggregate that is added to said paste before said accelerator is added to said paste.

10. The method of claim 6, wherein said precursor comprises at least one of an inorganic, amorphous alumino-silicate mineral material, metakaolin, a naturally-calcined caolinitic clay mineral, a laterite, a ferro-sialate, metallurgical slag, a volcanic tuff, a mine tailing, a silica fume, microsilica, a zeolite, pumice, a pozzolanic material, mika, muscovite or a mix of any of thereof.

11. The method of claim 6, wherein said accelerator comprises at least one of gehlenite, akermanite, belite, alite, monocalcium aluminate, and anorthite.
